(19) United States
(12) Patent Application Publication
(10) Pub. No.: US 2014/0259711 A1
(43) Pub. Date: Sep. 18, 2014

(54) North Orienting Device

(71) Applicant: ISC8 Inc., Costa Mesa, CA (US)

(72) Inventor: Itzhak Sapir, Irvine, CA (US)

(21) Appl. No.: 14/208,279

(22) Filed: Mar. 13, 2014

Related U.S. Application Data
(60) Provisional application No. 61/779,346, filed on Mar. 13, 2013.

(51) Int. Cl. G01C 17/00

(52) U.S. Cl. CPC G01C 17/00
USPC 33/300

(57) ABSTRACT

A device capable of measuring the vector sum of the centripetal acceleration of the rotation of the Earth (or that of any other planet in a planetary system) around its axis (a.sub.rot) and the centripetal acceleration of the planet's revolution in its orbit around the Sun (a.sub.rev) and a method for performing the same using the measured physical data to calculate the latitude and longitude of the device on a surface. Measurements are taken by stepping accelerometers through different axis to determine centripetal acceleration, reading the output of the accelerometers and reading the angular disposition of the accelerometers using encoders and calculating the latitude and longitude from the measured data.

### CROSS-REFERENCE TO RELATED APPLICATIONS

This application claims the benefit of U.S. Provisional Patent Application No. 61/779,346, filed on Mar. 13, 2013 entitled “North Orienting Device” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of compass and direction-finding devices.

More specifically, the invention relates to a lightweight, low-power north orienting device for use in existing magnetic compass applications that is substantially immune from exterior or environmental magnetic effects such as from local deposits of magnetite or iron ore.

2. Background of the Invention

Military and other applications have use for a small, lightweight and low-power north orienting device for use in unattended ground sensors to replace inaccurate magnetic compasses currently in use. The inaccuracy of prior art magnetic compasses used in UGS in certain environments may be attributable in part to their proximity to soil deposits of magnetite or iron ore which is known to cause deviations in magnetic compasses.

Prior art north orienting devices for military UGS currently rely on magnetic compasses with these undesirable deviations and inaccuracies as stated above.

The instant invention does not rely on Earth's magnetic field for north orientation determination but rather measures the direction of two naturally-occurring vectors that are not influenced by magnetic or electrical fields.

The device and method of the invention take advantage of certain physical constants in a manner similar to what is disclosed in U.S. Pat. No. 7,822,549, “Global Positioning Using Planetary Constants”, issued to the instant inventor here. That is, instead of using the Earth's magnetic field as in prior art compass devices, the north orienting device of the invention determines the direction of north by measuring the direction of two vectors; i.e., gravity and the centripetal acceleration of the Earth's rotation. The north direction, as determined by the north orienting device of the invention, is “true north” rather than the magnetic north.

The north orienting device of the invention may comprise means for relating the north direction as determined by these two vectors to an UGS enclosure and its sensors.

### SUMMARY OF THE INVENTION

In a first aspect of the invention, a location measurement device is disclosed comprising a reference member having at least two degrees of freedom and coupled to a frame, wherein the reference member includes a rotatable end, an arm pivotably coupled to the rotatable end and having an axis, a rotatable head rotatably coupled to the arm, wherein the rotatable head includes a first inertial measurement device configured to measure acceleration parallel to the axis of the arm and a second inertial measurement device configured to measure acceleration perpendicular to the axis of the arm, and a computation module configured to determine a position of the reference member relative to a body based on at least one measurement of the first inertial measurement device while the frame is stationary.

In a second aspect of the invention, one end of the reference member comprises a weighted end, and wherein the device further comprises a locking mechanism configured to lock the reference member to the frame.

In a third aspect of the invention, the computation module is further configured to align the reference member to a gravitational vector associated with the body, to rotate the reference member and the arm to a first position where an acceleration reading of the first inertial measurement device is maximized, and to determine the position of the reference member relative to the body based on the acceleration reading.

In a fourth aspect of the invention, the first inertial measurement device and the second inertial measurement device comprise an accelerometer.

In a fifth aspect of the invention, the accelerometer may be one of a piezoelectric, piezo-resistive, or a microelectromechanical system (MEMS) accelerometer.

In a sixth aspect of the invention, the rotatable end further comprises at least one first encoder and a first motor, and wherein the rotatable head farther comprises at least one second encoder and a second motor.

In a seventh aspect of the invention, a location measurement device is disclosed comprising a reference member configured to align with a gravitational vector of a body, and a first inertial measurement device configured to align with an equivalent vector including a rotation vector and a revolution vector of the body, wherein an acceleration reading of the first inertial measurement device and the alignment of the first inertial measurement device are associated with a position of the reference member relative to the body.

In an eighth aspect of the invention, a second inertial measurement device is configured to align normal to a plane defined by the rotation vector and the revolution vector.

In a ninth aspect of the invention, a computation module is configured to: determine a first revolution vector based on a first measurement by the second inertial measurement device at a first time and a second measurement by the second inertial measurement device at a second time; determine a first rotation vector based on the first revolution vector; and determine a latitude of the reference member based on the first rotation vector.

In a tenth aspect of the invention, the computation module is further configured to determine a longitude of the reference member based on acceleration characteristics of a reference longitude.

In an eleventh aspect of the invention, the computation module is further configured to determine a hemisphere of the latitude by comparing the first rotation vector and the first revolution vector to the gravitational vector when a longitude vector of the device relative to the body is pointed opposite of the direction of the first revolution vector.

In a twelfth aspect of the invention, a computation module is configured to measure the equivalent vector for at least three-quarters of a rotation of the body, determine a first midway equivalent vector and a second midway equivalent vector, wherein the first midway equivalent vector occurs halfway between a maximum equivalent vector and a minimum equivalent vector during the rotation, and wherein the second midway equivalent vector occurs halfway between the minimum equivalent vector and the maximum equivalent vector during the rotation, determine the revolution vector based on the first midway equivalent vector and the second midway equivalent vector; determine a first rotation vector based on the revolution vector, and determine a latitude of the device based on the first rotation vector.

In a thirteenth aspect of the invention, the device may comprise an altimeter wherein the determination of the latitude is based, at least in part, on a reading of the altimeter.

In a fourteenth aspect of the invention, a location measurement device is disclosed comprising a reference member, an arm pivotably mounted to the reference member, and an accelerometer coupled to the arm, and a computation module configured to align the reference member to a gravitational vector associated with a body at a first time, pivot the arm to a first position where a first acceleration reading of the accelerometer is maximized, at a second time, pivot the arm to a second position where a second acceleration reading of the accelerometer is maximized; and determine a position of the reference member relative to the body based on the first acceleration reading and second acceleration reading.

In a fifteenth aspect of the invention, the reference member is configured to be adjusted by a compensation angle that corrects for rotational and revolution effects of the body.

In a sixteenth aspect of the invention, a vibration compensator is associated with the reference member and is configured to compensate for a vibration.

In a seventeenth aspect of the invention, the computation module comprises a look-up table including acceleration characteristics associated with latitudes and longitudes of the body.

### BRIEF DESCRIPTION OF THE DRAWINGS

FIG. 1 shows a side cross-section of the north orienting device of the invention with respect to the surface of the Earth.

FIGS. 2a and 2b illustrate a schematic representation of the g and arot vectors with respect to the north orienting device, an unattended ground sensor (also referred to as “UGS” herein) and the Earth.

FIG. 3 is a schematic representation of the north orienting device of the invention and all axes of rotation.

FIG. 4 illustrates arot direction error vs. resulting north direction error.

The invention and its various embodiments can now be better understood by turning to the following description of the preferred embodiments which are presented as illustrated examples of the invention in any subsequent claims in any application claiming priority to this application. It is expressly understood that the invention as defined by such claims may be broader than the illustrated embodiments described below.

### DETAILED DESCRIPTION OF THE INVENTION

Turning now to the figures wherein like references define like elements among the several views, Applicant discloses a north orienting device for use in existing magnetic compass applications such as in an unattended ground sensor assembly.

FIG. 1 depicts a schematic view of the north orienting device of the invention with the vectors to be used for north orientation determination. An explanation of the principle of operation, description of major components and first order calculations of accuracy is provided below.

The disclosed north orienting device takes advantage of two measurable physical and naturally occurring vectors to establish the direction of north. The two vectors are: 1) gravity (g) and, 2) the vector of centripetal acceleration of Earth rotation (arot).

FIG. 1 above and FIGS. 2a and 2b graphically illustrate these vectors with respect to Earth and to the north orienting device of the invention. Only the direction of the g and arot vectors is needed by the device for north determination. However, the arot vector's known magnitude in several locations is preferably used for the initial calculation of the system's accuracy and for the selection of an element of the invention; a unidirectional accelerometer.

The operational theory of north determination used by the north orienting device of the invention is that once the direction of the g and a rot vectors is determined as described below, the north direction will necessarily be the horizontal direction (locally with respect to Earth's surface) that resides within the plane defined by the two vectors. True north is the direction of the horizontal projection of the arot vector in the northern hemisphere whereas in the southern hemisphere, it points in the opposite direction (See FIG. 2b).

The device described below is a preferred embodiment of the north orienting device of the invention and the detailed description of a preferred embodiment of the device is intended to make it easier to understand the concept as well as to establish a baseline for size and power consumption such device.

The north orienting device of the invention may comprises a dual-axis gimbal first mechanism that permits a weight to be directed or oriented toward the Earth's center of gravity at any random orientation of the UGS frame and enclosure much like a plumb line weight. The weight as shown is a representation of the combined weights of all the gimbaled components balanced around the gimbal's axes. The two axes of rotation of the gimbals (g1 and g2 in FIG. 3) include rotary encoders that permit the reading of the angular orientation of each axis.

A second mechanism, coupled to the weight, may comprise a miniature motor-encoder that permits the controlled rotation and orientation determination of the second mechanism around axis g.

A third mechanism as seen in FIG. 3 comprises a unidirectional accelerometer that is driven by a miniature motor-encoder about the rot1 axis.

After the UGS is placed on the ground, the gimbals settle and the direction of the g vector is thus established. At the same time, after receiving location data from a GPS, latitude information is established. Based on the received latitude, the rot1 motor-encoder (FIG. 3) sets the arot angle (FIG. 2a) to the correct known value using its embedded encoder.

The arot angle is the angle between the arot vector and the g vector for each latitude and can be computed on board or stored in a lookup table in an electronic memory.

With the arot angle set to its correct value and the g vector pointing to the correct direction, the north orienting device of the invention next needs to find and point the arot vector to its correct direction. This is performed using the g motor-encoder (FIG. 3) rotating slowly in one direction looking for a maximum reading of the unidirectional accelerometer.

When a maximum reading is achieved, the motor slowly scans around that point to fine tune the orientation of the maximum value reading. When this step is completed, the direction of the arot vector is determined.

All the encoders are then read for final orientation determination. True north is thus accurately determined by the encoder readings of the two motor-encoders (g and rot1—FIG. 3) while the orientation of the UGS and its sensors with respect to true north is determined by the readings from the encoders on the g1 and g2 axes (FIG. 3).

True North vs. Grid North: True north is commonly defined as the direction to the north celestial pole which is an imaginary point in the sky that the Earth's axis of rotation passes through. Due to the precession of Earth's axis of rotation, this point is not fixed with respect to Earth's surface and thus cannot be used in maps or for determining a heading,

The north orienting device of the invention, by the nature of its method of obtaining the north direction, finds the true north (the direction to the celestial pole) but this direction is the instantaneous true north and not the grid (or “map”) north. The relationship between instantaneous true north and grid north, taking precession into account, is known for any point in time and can be applied to the north orienting device of the invention to obtain the grid north if needed.

The Earth's gravitational field is not uniform either in its magnitude or in the direction of the g vector. Changes in the magnitude of the g vector due to latitude, altitude and uniformly distributed Earth mass do not affect the north orienting device's results. However, deviations from the theoretical direction of the g vector due non-uniform distribution of Earth mass may influence she results. This type: of deviation from the theoretical direction, of the g vector is commonly referred to as “Vertical Deflection” (VD).

VD is greater in steep mountain areas and smaller on flat terrain. The deflection of the vertical can reach 20″ (0.006°) in lowland regions and up to 70″ (0.023°) in regions of ragged terrain (Source—Bomford, 1980). In Australia, the largest measured deflection of the vertical is around 30″ (Source—Fryer, 1971). Additional data for VD show a maximum value of 50″ (0.015°) in the Austrian Alps and 100″ (0.03°) in the Himalayas (Source—Wikipedia).

Comparing to the accuracy requirements from the north orienting device of the invention (+/−2° in phase I and +/−1° in phase II), the error contributed by VD in most areas on Earth is negligible.

A consideration for proper operation of the north orienting device of the invention is applying the correct calibration technique to the accelerometer. Since the calibration of the accelerometer is done When on the surface of the Earth, it is constantly subjected to the same vector it will need to measure. Unless the device accelerometer receives the direction and magnitude of the measured vector during calibration, it will not be able to detect it.

The calibration process for the unidirectional accelerometer may comprise the steps of pointing or directing it to the correct direction (i.e., the direction of the axis of rotation of the Earth) using external precision positioning means and then setting the output reading to a value of zero. By doing so, the accelerometer is able to measure deviations from the theoretical direction of arot with a voltage output corresponding to the angular error.

In order for the north orienting device of the invention to generate a north direction, the g and arot vectors desirably should not coincide. If both vectors were to point in the same direction, no plane can be created and the direction of north cannot be determined. Such is the case on the Equator where both vectors point in the same direction. The Equator then becomes a singularity line for the system where it cannot effectively operate.

A SolidWorks CAD model was created by Applicant to translate an error in the measured direction of the arot vector perpendicular to the baseline plane to an error in the north direction output.

FIG. 4 is a graphical representation of that model. The two sets of results obtained from the model are:
arot vector direction error of 0.5° results 1° error in north direction output,
arot vector direction error of 1° results 2° error in north direction output.

Arot Magnitude-Calculation

r₀=6,370,000 m (Earth's radius of rotation at the equator)

r₇₀=1,090,000 m (Earth's radius of rotation at 70 latitude)

v₀=2*π*r/t=40 e⁶m/86,400 sec=463 m/sec (tangential velocity at the equator)

v₇₀=6.85 e⁶m/86,400 sec=79.3 m/sec (tangential velocity at 70 latitude)

a₀=v²/r=463²/6,370,000=0.033 m/sec² (Earth centripetal acceleration at the equator)

a₇₀=v²/r=79.3²/1,090,000=0.006 m/sec² (Earth centripetal acceleration at 70 latitude)

The magnitude of the arot vector close to the equator is 0.033 m/sec² and in latitude 70 it is 0.006 m/sec². These two values are used to determine the accuracy envelope of the north orienting device of the invention on most of Earth's surface.

Calculation of Δarot

Aarot as a function of angular error is:

Δarot=arot−arot′

Where arot is the magnitude of the arot vector and arot′ is the magnitude of the deviated arot vector.

arot′=arot*cos α (where α is the angular error)

An angular error of 1° for the arot vector is used (corresponding to 2° of north direction error as shown by the CAD model) to determine αarot.

Δarot₀=0.033 m/sec²−(0.033 m/sec²*cos 1°)=5 e⁻⁶m/sec² (near the equator)

Δarot₇₀=0.006 m/sec²−(0.006 m/sec²*cos 1°)=1 e⁻⁶m/sec² (70 latitude)

The output voltage of an exemplar KB12VD accelerometer (with 10,000 mV/g) when measuring αarot₀ is:

V₀=10,000 mV*5 e⁻⁶m/sec²/9.8 m/sec²=0.005 mV=5 μV

The output voltage of the KB12VD accelerometer (with 10,000 mV/g) when measuring αarot₇₀ is:

V₀=10,000 mV*1 e⁻⁶m/sec²/9.8 m/sec²=0.001 mV=1 μV

Measuring these voltage levels require that the north orienting device of the invention includes a nano-voltmeter circuit. An off-the-shelf Keithley 2182A nano-voltmeter may be used. This off-the-shelf instrument is capable of performing a number of tasks and works on a large range of measured values.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the fact that the elements of such a claim may be set forth in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a subcombination or variation of a subcombination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

I claim:

1. A location measurement device for use in stationary applications comprising: a reference member having at least two degrees of freedom and coupled to a frame, wherein the reference member includes a rotatable end; an arm pivotably coupled to the rotatable end and having an axis; a rotatable head rotatably coupled to the arm, wherein the rotatable head includes a first inertial measurement device configured to measure acceleration parallel to the axis of the arm and a second inertial measurement device configured to measure acceleration perpendicular to the axis of the arm; and a computation module configured to determine a position of the reference member relative to a body based on at least one measurement of the first inertial measurement device while the frame is stationary.

2. The device of claim 1, wherein one end of the reference member comprises a weighted end, and wherein the device further comprises a locking mechanism configured to lock the reference member to the frame.

3. The device of claim 1, wherein the computation module is further configured to: align the reference member to a gravitational vector associated with the body; rotate the reference member and the arm to a first position where an acceleration reading of the first inertial measurement device is maximized; and determine the position of the reference member relative to the body based on the acceleration reading.

4. The device of claim 1, wherein the first inertial measurement device and the second inertial measurement device comprise an accelerometer.

5. The device of claim 4, wherein the accelerometer is one of a piezoelectric, piezo-resistive, or a microelectromechanical system (MEMS) accelerometer.

6. The device of claim 1, wherein the rotatable end further comprises at least one first encoder and a first motor, and wherein the rotatable head further comprises at least one second encoder and a second motor.

7. A location measurement device for use in stationary applications comprising: a reference member configured to align with a gravitational vector of a body; and a first inertial measurement device configured to align with an equivalent vector including a rotation vector and a revolution vector of the body; wherein an acceleration reading of the first inertial measurement device and the alignment of the first inertial measurement device are associated with a position of the reference member relative to the body.

8. The device of claim 7, further comprising a second inertial measurement device configured to align normal to a plane defined by the rotation vector and the revolution vector.

9. The device of claim 8, further comprising a computation module that is configured to: determine a first revolution vector based on a first measurement by the second inertial measurement device at a first time and a second measurement by the second inertial measurement device at a second time; determine a first rotation vector baaed on the first revolution vector; and determine a latitude of the reference member based on the first rotation vector.

10. The device of claim 9, wherein the computation module is further configured to determine a longitude of the reference member based on acceleration characteristics of a reference longitude.

11. The device of claim 10, wherein the computation module is further configured to determine a hemisphere of the latitude by comparing the first rotation vector and the first revolution vector to the gravitational vector when a longitude vector of the device relative to the body is pointed opposite of the direction of the first revolution vector.

12. The device of claim 7, further comprising a computation module configured to: measure the equivalent vector for at least three-quarters of a rotation of the body; determine a first midway equivalent vector and a second midway equivalent vector, wherein the first midway equivalent vector occurs halfway between a maximum equivalent vector and a minimum equivalent vector during the rotation, and wherein the second midway equivalent vector occurs halfway between the minimum equivalent vector and the maximum equivalent vector during the rotation; determine the revolution vector based on the first midway equivalent vector and the second midway equivalent vector; determine a first rotation vector based on the revolution vector; and determine a latitude of the device based on the first rotation vector.

13. The device of claim 12, further comprising an altimeter, wherein the determination of the latitude is based, at least in part, on a reading of the altimeter.

14. A location measurement device for use in stationary applications comprising: a reference member; an arm pivotably mounted to the reference member; and an accelerometer coupled to the arm; and a computation module configured to: align the reference member to a gravitational vector associated with a body; at a first time, pivot the arm to a first position where a first acceleration reading of the accelerometer is maximized; at a second time, pivot the arm to a second position where a second acceleration reading of the accelerometer is maximized; and determine a position of the reference member relative to the body based on the first acceleration reading and second acceleration reading.

15. The device of claim 14, wherein the reference member is configured to be adjusted by a compensation angle that corrects for rotational and revolution effects of the body.

16. The device of claim 14, further comprising a vibration compensator associated with the reference member.

17. The device of claim 14, wherein the computation module comprises a look-up table including acceleration Characteristics associated with latitudes and longitudes of the body.
